(19) United States
(12) Patent Application Publication
(10) Pub. No.: US 2025/0042792 A1
(43) Pub. Date: Feb. 6, 2025

(54) ENCAPSULATED BIOFILM COMPOSITIONS AND METHODS

(71) Applicant: REGENTS OF THE UNIVERSITY OF MINNESOTA, Minneapolis, MN (US)

(72) Inventors: Paige Jennifer Novak, Minneapolis, MN (US); William A. Arnold, Minneapolis, MN (US); Gretchen Marie Gutenberger, St. Louis Park, MN (US); Zhiyue Wang, Honolulu, HI (US); Annesh Borthakur, Los Angeles, CA (US); Natasha C. Wright, Minneapolis, MN (US); Siming Chen, Beijing (CN)

(21) Appl. No.: 18/748,562

(22) Filed: Jun. 20, 2024

Related U.S. Application Data
(60) Provisional application No. 63/597,404, filed on Nov. 9, 2023.
(60) Provisional application No. 63/522,131, filed on Jun. 20, 2023.

(51) Int. Cl. C02F 3/34; C02F 3/00; C02F 3/28; C02F 103/32

(52) U.S. Cl. CPC C02F 3/348; C02F 3/2806; C02F 3/341; C02F 2003/003; C02F 2103/32

(57) ABSTRACT

A biofilm composition includes a biofilm encapsulated within an encapsulant. In one or more embodiments, the biofilm includes a support material and a community of microorganisms. In one or more of these embodiments, the material supporting the biofilm includes biochar or powdered activated carbon. The composition may be used to treat wastewater.

### CROSS-REFERENCE TO RELATED APPLICATION

This application claims the benefit of U.S. Provisional Patent Application No. 63/522,131, filed Jun. 20, 2023, and U.S. Provisional Patent Application No. 63/597,404, filed Nov. 9, 2023, each of which is incorporated herein by reference in its entirety.

### GOVERNMENT FUNDING

This invention was made with government support under DE-EE0009501 awarded by the U.S. Department of Energy. The government has certain rights in the invention.

### SUMMARY

This disclosure describes, in one aspect, a composition that includes a biofilm encapsulated within an encapsulant. The biofilm includes at least two species of microbes.

In one or more embodiments, the biofilm includes a support material on which at least a portion of the microbes grow. In one or more of these embodiments, the support material includes biochar or powdered activated carbon.

In one or more embodiments, microbes in the biofilm are in sufficient proximity to one another to exchange metabolites.

In one or more embodiments, the encapsulant includes polyethylene glycol (PEG).

In one or more embodiments, at least one species of microbe in the biofilm is selected based on its ability to consume a component of wastewater.

In one or more embodiments, at least one species of microbe in the biofilm is selected based on its ability to produce a desirable product. In one or more of these embodiments, the desirable product is methane, hydrogen, a medium chain fatty acid, a lipid, acetate, an alcohol, a hydrocarbon, a polymerizable monomer, or a compound that is a precursor for production of a commercial or industrial chemical.

In one or more embodiments, at least one species of microbe in the biofilm is selected based on its ability to exchange metabolites with another species of microbe in the biofilm.

In another aspect, this disclosure describes a composition that generally includes a first group of particles and second group of particles. Particles of the first group generally include a first biofilm encapsulated by a first encapsulant. Particles of the second group generally include a second biofilm encapsulated by a second encapsulant.

In another aspect, this disclosure describes a method of treating wastewater. Generally, the method includes contacting wastewater with a composition that includes a biofilm encapsulated by an encapsulant.

In one or more embodiments, the wastewater includes high strength wastewater.

In one or more embodiments, at least one species of microbe in the biofilm is selected based on its ability to consume a component of the wastewater.

In one or more embodiments, at least one species of microbe in the biofilm is selected based on its ability to produce a desirable product. In one or more of these embodiments, the desirable product is methane, hydrogen, a medium chain fatty acid, a lipid, acetate, an alcohol, a hydrocarbon, a polymerizable monomer, or a compound that is a precursor for production of a commercial or industrial chemical. In one or more embodiments, the method further includes capturing at least a portion of at least one product of treating the wastewater.

In one or more embodiments, at least one species of microbe in the biofilm is selected based on its ability to exchange metabolites with another species of microbe in the biofilm.

In another aspect, this disclosure describes a method of preparing a composition that includes a biofilm encapsulated by an encapsulant. Generally, the method includes growing a community of microorganisms on a biofilm-supporting surface to form a biofilm and encapsulating the biofilm with an encapsulant. The community of microorganisms used to form the biofilm includes at least two species of microbes.

In one or more embodiments, the biofilm-supporting surface includes powdered activated carbon or biochar.

In one or more embodiments, at least one species of microbe in the biofilm is selected based on its ability to exchange metabolites with another species of microbe in the biofilm.

In one or more embodiments, at least one species of microbe in the biofilm is anaerobic.

In one or more embodiments, the community of microorganisms in the biofilm produces methane from wastewater.

In one or more embodiments, the community of microorganisms in the biofilm produces hydrogen gas from wastewater.

The above summary is not intended to describe each disclosed embodiment or every implementation of the present invention. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE FIGURES

FIG. 1. Schematic cross section illustration of an encapsulant containing bacteria.

FIG. 2. Methane yield from anaerobic biofilms grown on biochar and powdered activated carbon (PAC).

FIG. 3. Biochar reduces ammonium persulfate (APS) toxicity. (A) Control: this APS exposure reduced the methane yield from the biomass (as shown in the dashed lines). (B) Biochar: biomass grown on biochar were more resilient to APS and recovered their methane generation when APS was removed.

FIG. 4. A schematic of an exemplary modular encapsulated two-stage anaerobic bioreactor (METAB) system designed to treat high-strength food and beverage wastewater.

FIG. 5. A schematic diagram of an exemplary three-stage system of reactors used to assess bead integrity. Data collection included bead count, biomass concentration, and gas production over one month.

FIG. 6. Specific hydrogen production rate in batch reactors containing a fermentative culture encapsulated in PEG beads (●) or alginate beads (□). Error bars represent the standard deviation of three replicate reactors. Reactors contained 10 PEG beads or about 100 alginate beads.

FIG. 7. Specific methane production rate of biomass encapsulated in PEG beads (●), and alginate beads (□). Error bars represent the standard deviation of three replicates. Reactors contained seven PEG beads or about 100 alginate beads.

FIG. 8. Specific methane production rate over the 8-day experimental period in triplicate batch reactors containing PEG-encapsulated methanogenic biomass. When more than 0.15 mg protein/bead was encapsulated, methane production was observed; Below 0.15 mg protein/bead, no methane was produced, indicating that the methanogens present were killed or severely inhibited. Error bars represent the standard deviation of three replicates.

FIG. 9. Cumulative methane production per bead in encapsulated microbial communities in granules (♦), PAC-supported biofilms (▴ and ●), and suspended biomass (□). Error bars show the standard deviation of three replicate reactors. Reactors with PEG beads encapsulating PAC-supported biofilms contained 11 (●) or 17 (▴) beads and reactors containing PEG beads encapsulating granular cultures contained 13 beads.

### DETAILED DESCRIPTION OF ILLUSTRATIVE EMBODIMENTS

This disclosure describes encapsulating powdered activated carbon (PAC)- and biochar-supported biofilms to improve the yield of products produced by microbes from wastewater. The term “biofilm” refers to bacteria growing in a layer on and attached to a biofilm support surface. Thus, a biofilm is in contrast to planktonic bacteria, which are bacteria that are not attached to a biofilm surface.

While described below in the context of an exemplary embodiment in which the microbes are anaerobic methanogenic species, the compositions and methods described herein can involve the use of any microbial community capable of producing a desired product from wastewater or degrading a pollutant in water or wastewater. The microbes may be naturally capable of producing the desired product, degrading a pollutant, or may be engineered to include one or more heterologous nucleic acids that encode one or more proteins that allow the microbe to produce the desired product or degrade a pollutant.

Wastewater is water contaminated with human, agricultural, or industrial wastes. Wastewater typically needs to be treated to remove pollutants. The organic matter contained in wastewater from industrial or municipal systems can become a valuable resource with waste-to-energy systems. In one exemplary embodiment, anaerobic microorganisms work together to first ferment wastewater to hydrogen, acids, and alcohols, and then degrade these intermediates to methane. Indeed, when organic waste decomposes in an oxygen-free environment—such as deep in a landfill—it releases methane gas. This methane can be captured and used to produce energy instead of being released into the atmosphere.

This disclosure describes compositions and methods involving encapsulated microbial biofilms that improve the treatment of wastewater. Existing technologies for increasing treatment of wastewater rely on energy intensive microbial separation/retention via membranes/polymer materials. In contrast, the methods described herein, involving encapsulating microorganisms in capsules, allow for an infinite solids retention time without the need for membrane separation during anaerobic wastewater treatment. When biofilms are grown on a support such as powdered activated carbon or biochar and then encapsulated in a matrix, microbial activity is enhanced. The increased microbial activity may be the result of the protective nature of the support, retention of the physical anaerobic community structure as part of a biofilm, or a combination of both.

In one aspect, this disclosure describes methods of preparing a composition that includes an encapsulated biofilm. Generally, the method includes growing microorganisms on a surface to form a biofilm and then encapsulating that biofilm and surface combination prior to use. Encapsulating the biofilm can improve transfer of metabolites (e.g., hydrogen, electrons, etc.) between microorganisms and/or protect the microorganisms from toxic encapsulant chemistries, thereby improving the degree of wastewater treatment and/or product (e.g., methane, hydrogen, etc.) yield from the encapsulated microorganisms. In one or more embodiments, the biofilm includes a community of microbes that includes microorganisms from two or more species. Exemplary microorganisms and their selection are described in more detail below.

In one or more embodiments, the surface can include powdered activated carbon (PAC), biochar, or a combination thereof.

Methods of encapsulating microbes and compositions containing encapsulated microbes are described in, for example, Wang, Z., Ishii, S., & Novak, P. J. (2021), Environmental Science: Water Research & Technology, 7(8), 1402-1416. https://doi.org/10.1039/D1EW00255D. Exemplary encapsulation matrix—i.e., the encapsulant—materials include, but are not limited to, polyethylene glycol as previously described (Gutenberger et al., (2024). Environmental Science: Water Research & Technology, 10(2), 467-479).

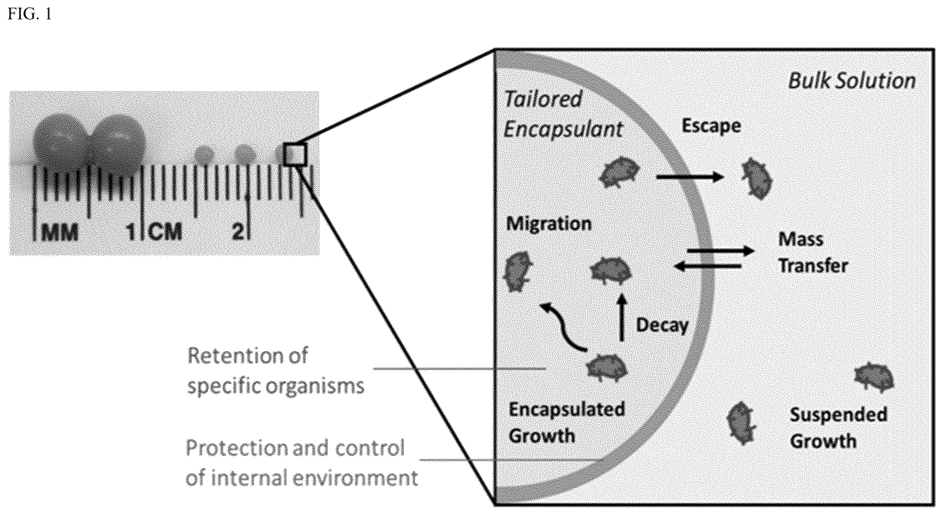

FIG. 1 provides a schematic cross section view of encapsulated biofilm. As shown, encapsulation allows the particle to retain the microbes of interest and to control the environment in which the microbes exist. The particles as shown in FIG. 1 have an average diameter of 2-5 millimeters. However, the particles may be designed and constructed to have an average diameter of any suitable size. Smaller particles generate greater surface area to volume ratio than particles with a larger surface area. Thus, the size of the particles and/or the sizes of particles in a mixture of particles of varying sizes can influence the efficiency of treatment of various components of the wastewater being treated.

In one or more embodiments, the composition can include more than one group of encapsulated biofilm particles. Thus, in one or more embodiments, a composition can include a first group of particles encapsulating a biofilm and a second group of particles encapsulating a biofilm. The first group of particles and the second group of particles may differ in any desired characteristic or parameter including, but not limited to, diameter, microorganism in the biofilm, the surface material of the biofilm, and/or the encapsulant. Thus, in one or more embodiments, the first group of particles can encapsulate a first biofilm and the second group of particles can encapsulate a second biofilm. In such embodiments, the first biofilm and the second biofilm can differ in one or more species of microorganisms in the community of microbes making up the biofilm.

In another aspect, this disclosure describes a method of treating wastewater. Generally, the method includes contacting wastewater with a composition that includes an encapsulated biofilm in which the biofilm includes an anaerobic microbe that produces a product of interest from wastewater.

In one or more embodiments, the wastewater can include high strength wastewater such as, but not limited to, dairy wastewater or brewery wastewater. As used herein, “high strength wastewater refers to wastewater having an average concentration of biochemical oxygen demand (BOD) greater than 300 milligrams-per-liter (mg/L) or of total suspended solids (TSS) greater than 330 mg/L or a fats, oil, and grease (FOG) concentration greater than 100 mg/L prior to the treatment.

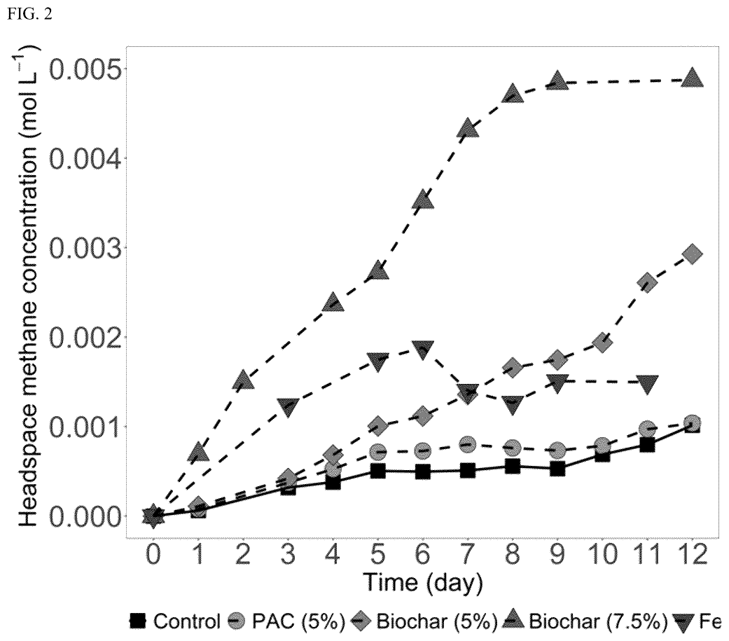

FIG. 2 shows data demonstrating that encapsulating powdered activated carbon (PAC)- or biochar-supported biofilms instead of planktonic bacteria significantly improved methane yield from wastewater. Adding PAC or biochar to produce a biofilm before encapsulating significantly improved methane yield from the wastewater compared to encapsulating planktonic bacteria. In one or more embodiments, the biofilm support surface PAC, biochar, or a combination thereof. Higher amount of biochar (7.5%) led to increased methane production compared to smaller amounts of biochar (5%), which still increased methane production compared to controls.

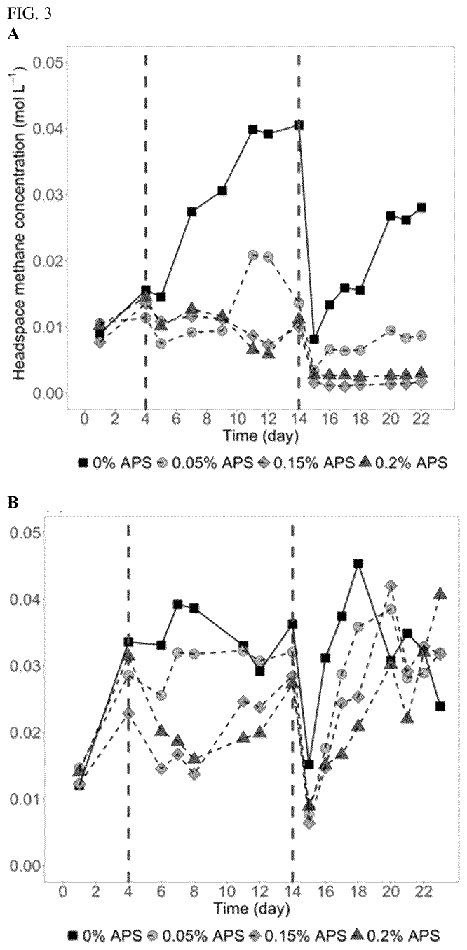

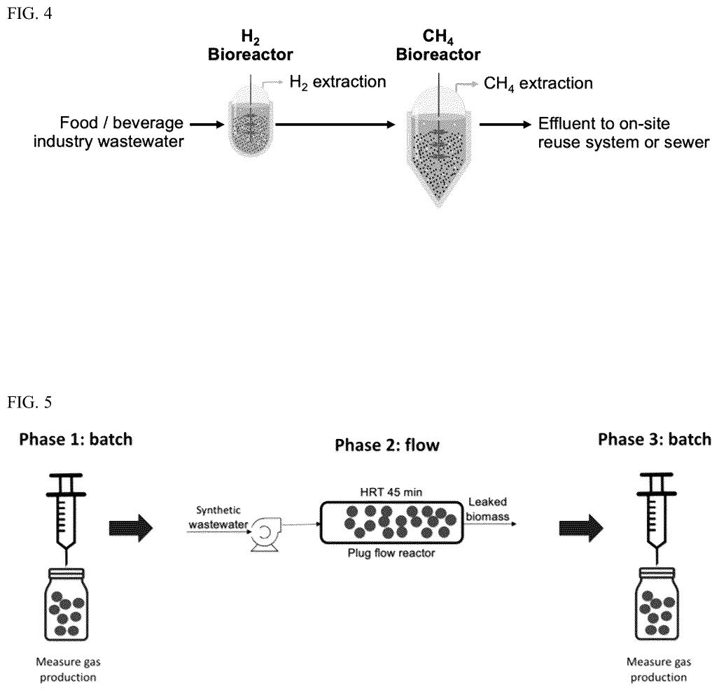

FIG. 3 provides data showing that biochar-supported anaerobic biofilms interfered with ammonium persulfate (APS) toxicity. FIG. 3A shows methane yield over time when biomass is exposed to different concentrations of APS. In contrast, FIG. 3B shows that biomass grown on biochar was more resilient to APS and recovered the ability to generate methane when APS was removed. This is important because APS is used in polymerizing the encapsulant PEG. Thus, biochar support can reduce the likelihood and/or extent that APS, when used during the polymerization of PEG as an encapsulant, has toxic effects on the microbial community in the biofilm. These results show that biochar may reduce toxicity effects of chemicals to which the biofilm may be exposed during encapsulation.

### Biofilm Composition and Selection of Microbial Species

The biofilm provides a community of microorganisms that include members of two or more species. While described herein in the context of an exemplary embodiment in which the microbial species in the biofilm are anaerobic, the biofilm can include any mutually compatible bacterial species, regardless of whether a particular species is an anaerobe, aerotolerant, a facultative anaerobe, a microaerophile, or an obligate anaerobe.

In one or more embodiments, at least one species of microbe in the biofilm is selected based on its ability to consume a component of the wastewater. In one or more embodiments, at least one species of microbe in the biofilm is selected based on its ability to produce a desirable product. Exemplary desirable products include, but are not limited to, methane, hydrogen, a medium chain fatty acid, a lipid, acetate, an alcohol, a hydrocarbon, a polymerizable monomer, or a compound that is a precursor for production of a commercial or industrial chemical. As used herein, a “polymerizable monomer” is a monomer that can be polymerized to form a homopolymer and/or polymerized with a comonomer to form a copolymer. In one or more embodiments, at least one species of microbe in the biofilm is selected based on its ability to exchange metabolites with another species of microbe in the biofilm. For example, one bacterial species in the biofilm may provide a metabolite (e.g., hydrogen, electrons, nutrients, vitamins, carbon substrates) to another bacterial species in the biofilm, thereby promoting metabolism in the recipient species. In one or more embodiments, the exchange of metabolites can be reciprocal (e.g., two-way) between bacterial species in the biofilm community. In one or more embodiments, at least one species of microbe in the biofilm is selected based on the intended culture conditions including, but not limited to, the amount of oxygen provided in the bioreactor, the residence time in the bioreactor, and the specific waste characteristics.

### Encapsulant

Multiple encapsulant chemistries were explored, with success criteria defined as the ability to be reproducibly and easily formed while physically maintaining integrity for at least four weeks in batch reactors, as determined visually. Overall, most of the encapsulant bead chemistries were unable to maintain integrity for four weeks (Table 1).

TABLE 1
Encapsulant chemistries

| | | | | Time that | |
|---|---|---|---|---|---|
| | | | | integrity was | |
| Bead | Bulk matrix | Additive | Procedure | maintained | Other comments |
| 1 | Alginate | — | Zhu et al., | Three | |
| | | | 2018¹6/20/2024 | weeks | |
| | | | 12:25:00 PM | | |
| 2 | Alginate | CaCO₃^{a} | Zhu et al., | Four | |
| | | | 2018¹ + 2.5 or | weeks | |
| | | | 5.0% CaCO₃ | | |
| 3 | Alginate | PAC^{b} | Zhu et al., | Two | Activated carbon leaked |
| | | | 2018¹ + 2.5 or | weeks | |
| | | | 5.0% PAC | | |
| 4 | ELVANOL ™ | — | 12/2% | Four | Beads broke down as |
| | PVA^{c} and | | PVA/alginate | weeks | alginate leaked out |
| | medium | | crosslinked in | | |
| | viscosity | | calcium | | |
| | alginate | | chloride and | | |
| | | | boric acid | | |
| 5 | 50-80k | — | 12/2% | Four | Beads broke down as |
| | molecular | | PVA/alginate | weeks | alginate leaked out |
| | weight PVA | | crosslinked in | | |
| | and low or | | calcium | | |
| | medium | | chloride and | | |
| | viscosity | | boric acid | | |
| | alginate | | | | |
| 6 | 50-80k | — | 12/2% | N/A | High viscosity mixture was |
| | molecular | | PVA/alginate | | difficult to extrude and |
| | weight PVA | | crosslinked in | | formed irregularly shaped |
| | or | | calcium | | beads |
| | ELVANOL ™ | | chloride and | | |
| | PVA and high | | boric acid | | |
| | viscosity | | | | |
| | alginate | | | | |
| 7 | ELVANOL ™ | PAC | 12/2% | 25 days | Activated carbon leaked |
| | PVA and | | PVA/alginate + | | |
| | medium | | 2.5 or 5.0% | | |
| | viscosity | | PAC | | |
| | alginate | | | | |
| 8 | PVA/alginate | — | Bae et al., | N/A | Individual beads congealed |
| | core-shell | | 2017² | | into a solid mass during the |
| | | | | | shell crosslinking step |
| 9 | PVA/alginate | PAC in | Modified Bae | Four | Beads broke down as |
| | core-shell | core | et al., 2017² | weeks | alginate leaked out |
| | | | with 0.4″ | | |
| | | | silicone mold | | |
| 10 | PEG^{d} | — | Sumino et al., | N/A | Polymerization occurred |
| | | | 1992³ | | too quickly to consistently |
| | | | | | get polymer solution into |
| | | | | | molds |
| 11 | PEG | — | Modified | >10 | |
| | | | Sumino et al., | months | |
| | | | 1992³ with | | |
| | | | 0.1% (w/v) | | |
| | | | APS | | |
| 12 | PEG | GAC^{e} | Modified | N/A | GAC sank to the bottom of |
| | | | Sumino et al., | | bead molds and did not |
| | | | 1992³ + 2% | | polymerize |
| | | | GAC | | |
| 13 | PEG | PAC | Modified | Four | Chipped into <2 mm pieces |
| | | | Sumino et al., | weeks | |
| | | | 1992³ + 2% | | |
| | | | PAC-grown | | |
| | | | biofilms | | |

¹Zhu, et al., Environmental Science: Water Research & Technology, 2018, 4, 1867-1876;
²Bae, et al., Chemical Engineering Journal, 2017, 322, 408-416;
³Sumino, et al., Journal of Fermentation and Bioengineering, 1992, 73, 37-42.
^{a}CaCO₃ is calcium carbonate.
^{b}PAC is powdered activated carbon.
^{c}PVA is polyvinyl alcohol.
^{d}PEG is polyethylene glycol.
^{e}GAC is granular activated carbon.

Because CaCl₂) is used to crosslink the alginate polymer, it was thought that the addition of solid CaCO₃ would improve bead integrity, continuing to stiffen the bead as the CaCO₃ dissolved and adding additional crosslinking. Although some benefit was observed, it was not sufficient to achieve the targeted bead integrity (Table 1, Bead 2). Likewise, PAC can improve encapsulant integrity via additional hydrogen bonding. However, although some benefit was observed, it was not sufficient to substantially improve bead integrity when PAC was added to either alginate or alginate/PVA mixtures (Table 1, Beads 3, 7). Several of the encapsulant bead chemistries proved to be too fragile (Table 1, Beads 4, 5), while others were difficult to form, or form reproducibly (Table 1, Beads 6, 8, 9, 10, 12), resulting in their exclusion from further testing. Ultimately, PEG (Table 1, Bead 11), also with incorporation of PAC (Bead 13), was selected for further study because of its relative ease of production and longevity. Indeed, when tested in a stirred reactor, the PEG beads (Bead 11) lasted for more than six months. In batch reactors PEG beads lasted for more than ten months with no apparent bead breakage or loss of shape.

As seen in Table 1, one challenge with the alginate-based encapsulants was their longevity. A previous study saw complete alginate encapsulant breakage and failure after only three weeks in brewery wastewater (Chen et al., Bioresource Technology, 2022, 126435). Some studies have observed alginate bead degradation in four to ten days (Cruz et al., Applied Microbiology and Biotechnology, 2013, 97, 9847-9858). PVA/alginate beads containing 2,4,6-trichlorophenol-enriched aerobic sludge have been shown to last 240 days in column reactors (Fatemeh Razavi-Shirazi, in Environmental and Pipeline Engineering 2000, 2000, pp. 358-367), and PEG beads have been shown to last for years at full scale (Isaka, et al., Biochemical Engineering Journal, 2017, 122, 115-122). Due to the different types of microorganisms and reactors used across these studies, however, the longevities reported in the literature cannot be directly compared to those reported herein, nor can literature values be extrapolated to use with anaerobic communities at the concentrations required for this study. Table 1 therefore allows for direct comparisons between different encapsulant chemistries containing identical quantities of anaerobic sludge tested in similar shaken batch reactors.

### PEG Encapsulant Chemistry Biocompatibility

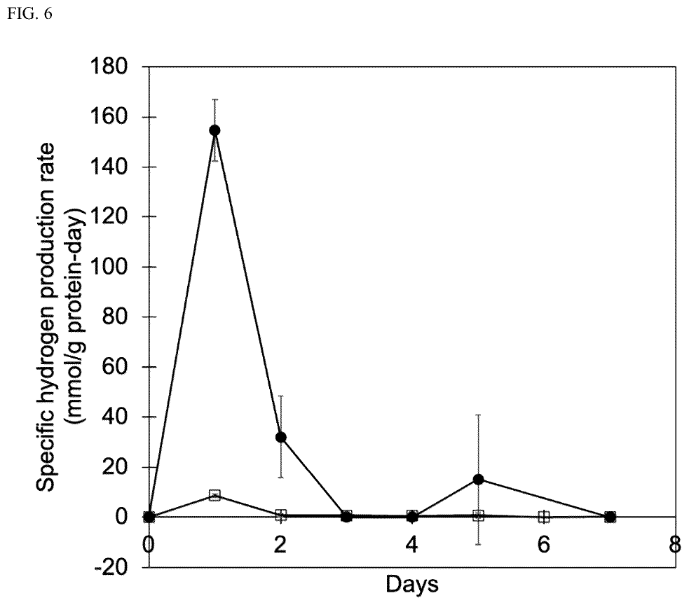

Because PEG encapsulants appeared to maintain their integrity well, the biocompatibility of the PEG encapsulant was tested. When encapsulating fermentative cultures, PEG (Table 1, bead 11) enabled a greater rate of biological hydrogen production than alginate (Table 1, bead 1) in batch reactors (FIG. 6).

The biomass concentration that could be successfully encapsulated in the PEG beads was greater than that encapsulated in the alginate beads. It is possible that the harsh encapsulation chemistry further enriched spore-forming hydrogen producers that were then able to grow and generate additional hydrogen once fed high strength wastewater. No methane production was observed in these experiments. PEG encapsulation appeared to be no more inhibitory than alginate encapsulation, with immediate hydrogen production observed, reaching a maximum rate one day after starting the experiment (FIG. 6).

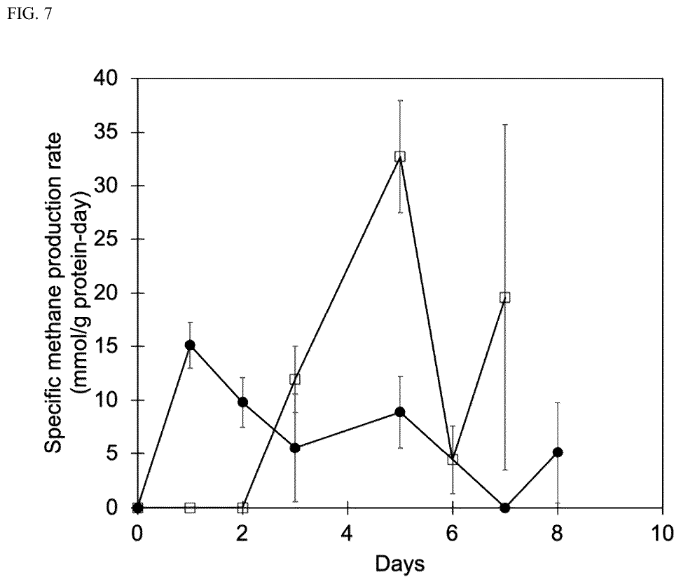

FIG. 7 shows the methane production rate for both PEG and alginate beads encapsulating methanogenic biomass. When the final protein concentration in the PEG beads was approximately 0.15 mg/bead, PEG (Table 1, bead 11) produced methane at a rate similar to alginate beads on a biomass-normalized basis.

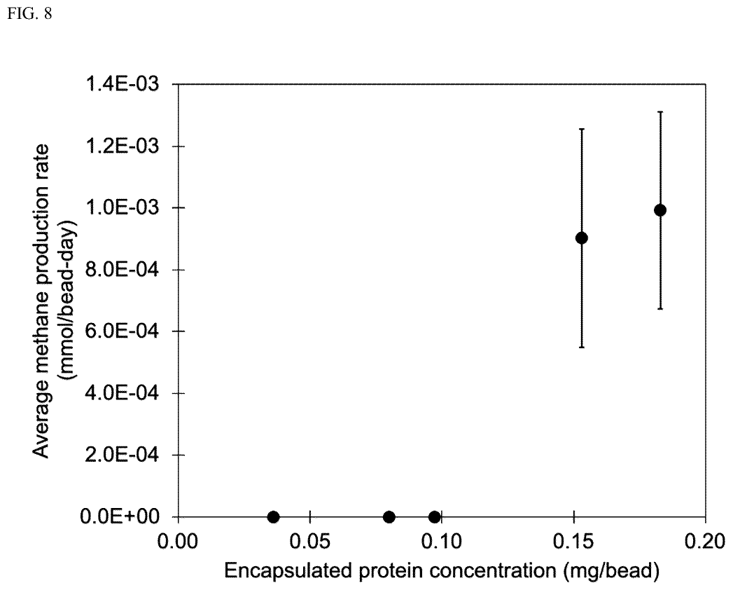

Interestingly, no lag period was observed before the PEG-encapsulated biomass began producing methane, whereas a short two-day lag period was observed with the alginate beads. This was unexpected because the PEG encapsulation method was much harsher than the alginate encapsulation method. Recovery time prior to microbial activity has been observed with other encapsulant chemistries, such as PVA/alginate. The lack of a lag period observed with the PEG beads was likely to have been a result of the high concentration of biomass that was encapsulated. In fact, methane production from the PEG-encapsulated biomass was only observed when a minimum threshold biomass concentration was encapsulated, with no methanogenic activity observed after the polymerization process when below this threshold concentration (FIG. 8). Indeed, at encapsulated protein concentrations of less than 0.15 mg protein/bead, no methane was produced from PEG beads (FIG. 8). Above 0.15 mg protein/bead, a further increase in encapsulated protein concentration increased the total amount of methane produced per bead (FIG. 8). Thus, higher biomass concentrations may provide greater degree of resistance to APS inactivation.

When compared to alginate, an extremely biocompatible encapsulant, PEG encapsulation can be used to successfully encapsulate both fermentative and methanogenic biomass as long as the biomass concentration encapsulated is sufficiently high. The initial concentration of encapsulated biomass has been shown to affect performance, but this is the first demonstration of manipulating the initial concentration of sensitive anaerobic biomass to enable the encapsulation of an active community in PEG.

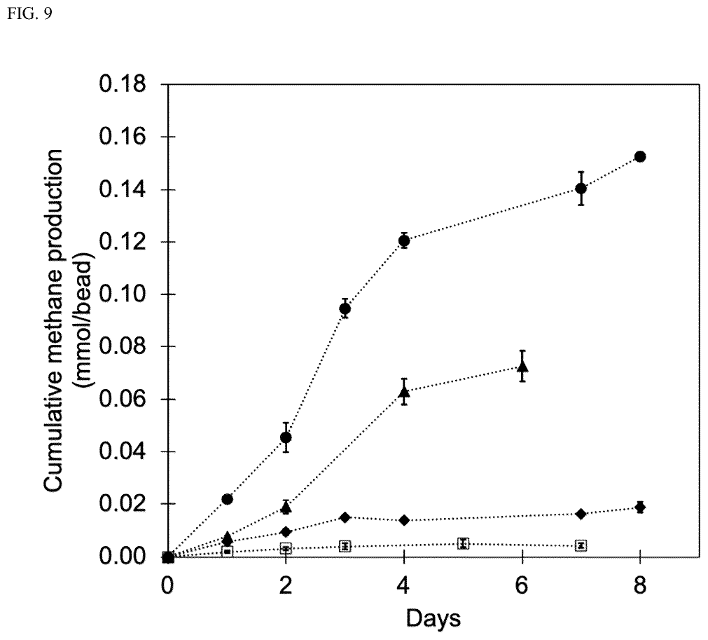

Because of the synergistic relationships present in methanogenic communities, methane production in PEG beads could be improved by encapsulating methanogenic communities already established as granules or biofilms (as compared to unaggregated, suspended, planktonic cultures). PEG beads encapsulating granular cultures had significantly higher cumulative gas production, 2.8 times more, compared to beads encapsulating suspended cultures (p=0.003) (FIG. 9). PEG beads encapsulating PAC-supported biofilms (Table 2, bead 13) achieved ˜20 times more methane production than encapsulated suspended cultures (p=3.8×10⁻⁴) and also significantly more methane production than granular cultures (p=7.4×10⁻⁴). Replicate batches of PAC-supported biofilms (shown as replicate experiments of triplicate reactors in FIG. 9) produced significantly different amounts of methane (p=2.7×10⁻⁴), likely as a result of different quantities of biomass grown on the PAC.

TABLE 2
Bead Activity and Quality After 30 Days

| | | Change over 30 days | | |
|---|---|---|---|---|
| | | | Number of intact | Gas produced |
| Bead type | Final bead quality | Protein (mg/bead) | beads | (mL/bead) |
| Alginate | Mushy and | 87.5% increase | 32.8% decrease | 11.4% decrease |
| | flexible | (p = 0.142) | (p = 9.23 × 10⁻³)* | (p = 0.355) |
| PEG | Rigid and robust | 8.58% decrease | No change | 2.99% decrease |
| | | (p = 0.861) | (p = 1.00) | (p = 0.263) |
| PEG + PAC | Chipped and | 57.2% decrease | 11.1% decrease | 4.61% increase |
| | cuttable | (p = 9.46 × 10⁻⁴)* | (p = 1.31 × 10⁻²)* | (p = 0.275) |

*p values ≤ 0.05.

Both granules and biofilms should maintain the methanogenic community structure, with syntrophic populations thereby able to retain an effective physical proximity when encapsulated. Indeed, the maintenance of these spatial relationships, in granules or biofilm grown on a substrate such as activated carbon, produces higher methanogenic activity than that observed in suspended biomass. The encapsulation of a PAC-supported biofilm enables better performance than that observed with encapsulated granules, possibly because of the degree to which the PAC insulated the biomass from toxic effects of APS, the biofilm density on the PAC, or direct interspecies electron or hydrogen transfer.

### Longevity and Leakage

The leakage of microbes from the PEG beads encapsulating PAC-supported biofilms or suspended fermentative cultures was also compared to alginate beads in three-stage reactors. Table 2 shows that the greatest difference between PEG beads encapsulating suspended cultures and alginate beads was in the number of beads intact after the experiment. Almost one-third of the alginate beads disintegrated over the experimental period of one month, whereas PEG beads were stable. Alginate beads became mushy and lacked structure after one month of incubation, while PEG beads encapsulating suspended cultures did not change in appearance.

Some of the alginate beads sampled almost doubled the quantity of encapsulated biomass present per bead over the course of the experiment. It is likely that this resulted in the maintenance of gas production, even while one-third of the beads were no longer intact. Because alginate is a more biocompatible polymer, this may enable greater encapsulated microbial growth than PEG. Nevertheless, it is likely that the excess biomass growth in the intact beads would eventually contribute to the encapsulants bursting. This, along with the loss of bead integrity in one-third of the beads would likely lead to substantial biomass loss and washout.

### Optimizing Reactor Conditions for PEG Beads Encapsulating PAC-Supported Biofilms

Four different reactor configurations, in addition to the plug flow reactor (PFR) used in the initial three-stage reactor set-up (FIG. 5), were investigated to determine how to best maximize bead longevity. In initial observational tests of PEG beads encapsulating PAC-supported biofilms, both magnetically stirred and overhead impeller reactors created conditions where beads were damaged within a few weeks.

Gentler conditions were created in PFRs and caged and upflow reactors. These reactors removed direct contact between beads and mixers and instead moved the wastewater past stationary beads. Table 3 shows the results of the three-stage experiments with different second-stage reactor types. While caged reactors—and, to a lesser extent, upflow reactors—maintained beads for longer than stirred or impeller reactors, bead performance (in terms of gas production) still decreased significantly over time.

TABLE 3
Bead activity and quality after 30 days in the three-stage reactor system

| | | Change over 30 days | | |
|---|---|---|---|---|
| | Final bead | | Number of intact | Gas produced |
| Reactor | quality | Protein (mg/bead) | beads | (mL/bead) |
| Plug flow | Slightly chipped | 57.2% decrease | 11.1% decrease | 4.61% increase |
| | and cuttable | (p = 9.46 × 10⁻⁴)* | (p = 1.31 × 10⁻²)* | (p = 0.275) |
| Caged | Whole but still | 12.7% increase | 0.904% decrease | 45.9% decrease |
| | soft | (p = 0.104) | (p = 0.423) | (p = 2.382 × 10⁻⁴)* |
| Upflow | Chipped and | 6.50% decrease | 23.6% decrease | 73.6% decrease |
| | cuttable | (p = 0.214) | (p= 1.88 × 10⁻²)* | (p = 3.998 × 10⁻⁵)* |

*p values ≤ 0.05.

PFRs were the most successful at maintaining bead integrity and supporting biomass growth across the five types of reactors investigated. In PFRs, protein concentration decreased by 57.2% over the three-stage experiment (p=9.5×10⁻⁴) but gas production was not affected. Beads in PFRs and upflow reactors demonstrated a marked difference in quality before and after their time in the reactors, as 11.1% and 23.6% of beads broke into pieces respectively, and those that remained, lost small chips of material. In caged reactors, the number of intact beads did not change after one month in the reactors and there was no significant change in protein concentration inside the beads. Despite the maintenance of bead integrity and an increase in protein content per bead, gas production by beads in the caged reactors decreased by 45.9% between the initial and final batch phases (p=2.3×10⁻⁴). A similar trend was observed for beads in the upflow reactors. While the protein concentration did not change, gas production decreased by 73.6% (p=4.0×10⁻⁵). Compared to the total bead disintegration observed in stirred and impeller reactors, PFRs and caged and upflow reactors were more successful in maintaining bead integrity. Nevertheless, when PEG was used to encapsulate PAC-supported biofilms, either gas production or protein concentration decreased significantly over the four-week experiment in all reactors. This suggests that more work is needed to create PEG encapsulants for PAC-supported biofilms that are capable of lasting longer so that the greatly improved gas production observed with these encapsulant beads can be taken advantage of in anaerobic biological systems such as the METAB system.

Thus, two-stage anaerobic communities were encapsulated for treating high-strength food and beverage wastewater. PEG was identified as a robust, long-lasting, biocompatible encapsulant. PEG beads encapsulating suspended biomass did not change in shape, activity, or protein concentration over one month, while one-third of alginate beads disintegrated over that same time. In reactors mixed by stir bars, PEG beads encapsulating suspended biomass have lasted at least 6-10 months. Five times more hydrogen per unit biomass and the same amount of methane per unit biomass was produced in PEG beads encapsulating suspended biomass compared to alginate beads. This should enable robust, low maintenance, distributed high strength wastewater treatment for small and mid-size food and beverage industries.

Each of the two-stage microbial communities was treated uniquely when encapsulated to address specific needs. More robust fermentative communities responded well to encapsulation, while more complex, less resilient methanogenic cultures required the encapsulation of higher biomass concentrations, granules, or biofilms grown on PAC to maintain methane production. Indeed, granules and biofilms grown on PAC were capable of significantly greater methane production than suspended biomass when encapsulated in PEG. The benefits of encapsulating biofilms grown on activated carbon could be direct interspecies electron and/or hydrogen transfer, increased surface area for dense microbial growth, or the retention of the physical relationships between synergistic microbes. Likely, a combination of these factors played a role in enhanced methane production in the encapsulated system.

While described above in the context of an exemplary embodiment in which PEG is the encapsulant, the compositions and methods described herein can involve the use of alternative encapsulants that provide characteristics to the encapsulated biofilm similar to those provided by PEG. For example, in one or more embodiments, a hydrophilic polymer such as chitosan may be used as an encapsulant.

### Process of Making

The biofilm may be prepared by growing a community of microorganisms on a biofilm-supporting surface to form a biofilm, and then encapsulating the biofilm with an encapsulant. As described in detail above, the community of microorganisms in the biofilm includes microbes from at least two bacterial species. Bacteria selected for the biofilm are grown under conditions appropriate for the selected bacteria to form a biofilm. Typically, the biofilm support material (e.g., biochar, PAC, etc.) is added to a culture of bacteria and the bacteria are allowed to form a biofilm.

Once formed, the biofilm is then encapsulated with an encapsulant. The encapsulant may be formed or molded as desired. For example, beads of polyethylene glycol (PEG)-encapsulated biofilm may be prepared by preparing a stock solution of biofilm to a desired stock concentration of biomass (e.g., 10 g/L). The stock biofilm solution is combined with components required to form the encapsulant. For example, when the encapsulant is PEG, the stock biofilm solution is combined with an appropriate prepolymer solution, PEG precursor, crosslinking agent, and polymerization initiator (e.g., ammonium persulfate, APS).

The precise amount of biomass—i.e., the total amount of microorganisms in the biofilm—encapsulated can vary depending on the microorganisms included in the biofilm and/or the desired product. For example, for methane production one may want to achieve close proximity (e.g., less than 10 μm) between microbes in the biofilm. To some degree however, the encapsulated biofilm exploits the natural tendency for the microbes in the biofilm to grow to a density (and thereby proximity to neighbors) that is most beneficial for that community—i.e., the microbes are grown to form a biofilm in which the microbes naturally adopt optimal spatial relationships with other members of the microbial community and then the biofilm is encapsulated.

### Methods

The encapsulated biofilms described herein can be applied for decentralized industrial wastewater treatment. In this aspect, the encapsulated microbial community can be selected to degrade target compounds. Optionally, the encapsulated biofilm may be designed to produce desired products including, but not limited to, energy-rich gases (e.g., hydrogen, methane, etc.), chemical precursors (e.g., polymerizable monomers), and other organic molecules (e.g., lipids, medium chain fatty acids, hydrocarbons, alcohols, etc.). Some of these products may be considered precursors for the chemical or biosynthetic production of commercial or industrial compounds of interest. For example, medium chain fatty acids can be converted to jet fuel, polymerizable monomers can be polymerized to form homopolymers or copolymers, some of which may be used to form plastics.

In one or more embodiments, the encapsulated biofilm can increase production of a desired product compared to production of the same product by a suspended culture of the same community of microorganisms. The encapsulated biofilm can provide an increase in production of a desired product of at least 10% compared to production the same product by the same community of microorganisms suspended in culture. Thus, for example, the increase in production can be at least 20%, at least 30%, at least 40%, at least 50%, at least 60%, at least 70%, at least 80%, at least 90%, or 100% or more.

In the preceding description and following claims, the term “and/or” means one or all of the listed elements or a combination of any two or more of the listed elements; the terms “comprises,” “comprising,” and variations thereof are to be construed as open ended—i.e., additional elements or steps are optional and may or may not be present; unless otherwise specified, “a,” “an,” “the,” and “at least one” are used interchangeably and mean one or more than one; and the recitations of numerical ranges by endpoints include all numbers subsumed within that range (e.g., 1 to 5 includes 1, 1.5, 2, 2.75, 3, 3.80, 4, 5, etc.).

As used herein, “have,” “has,” “having,” “include,” “includes,” “including,” “comprise,” “comprises,” “comprising” or the like are used in their open ended inclusive sense, and generally mean “include, but not limited to,” “includes, but not limited to,” or “including, but not limited to.” Further, wherever embodiments are described herein with the language “have,” “has,” “having,” “include,” “includes,” “including,” “comprise,” “comprises,” “comprising” and the like, otherwise analogous embodiments described in terms of “consisting of” and/or “consisting essentially of” are also provided. The term “consisting of” means including, and limited to, that which follows the phrase “consisting of.” That is, “consisting of” indicates that the listed elements are required or mandatory, and that no other elements may be present. The term “consisting essentially of” indicates that any elements listed after the phrase are included, and that other elements than those listed may be included provided that those elements do not interfere with or contribute to the activity or action specified in the disclosure for the listed elements.

In the preceding description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

In several places throughout the above description, guidance is provided through lists of examples, which examples can be used in various combinations. In each instance, the recited list serves only as a representative group and should not be interpreted as an exclusive list.

For any method disclosed herein that includes discrete steps, the steps may be performed in any feasible order. And, as appropriate, any combination of two or more steps may be performed simultaneously.

As used herein, the terms “preferred” and “preferably” refer to embodiments of the invention that may afford certain benefits under certain circumstances. However, other embodiments may also be preferred under the same or other circumstances. Furthermore, the recitation of one or more preferred embodiments does not imply that other embodiments are not useful and is not intended to exclude other embodiments from the scope of the invention.

### ILLUSTRATIVE EMBODIMENTS

Embodiment 1. A composition comprising a biofilm comprising at least two species of microbes; and an encapsulant encapsulating the biofilm.

Embodiment 2. The composition of Embodiment 1, wherein the biofilm comprises a support material on which at least a portion of the microbes grow.

Embodiment 3. The composition of Embodiment 2, wherein the support material comprises biochar or powdered activated carbon.

Embodiment 4. The composition of any one of Embodiments 1-3, wherein members of the at least two species of microbes are in sufficient proximity to exchange metabolites.

Embodiment 5. The composition of any one of Embodiments 1-4, wherein the encapsulant includes polyethylene glycol (PEG).

Embodiment 6. The composition of any one of Embodiments 1-5, wherein at least one species of microbe in the biofilm is selected based on its ability to consume a component of wastewater.

Embodiment 7. The composition of any one of Embodiments 1-6, wherein at least one species of microbe in the biofilm is selected based on its ability to produce a desirable product.

Embodiment 8. The composition of Embodiment 7, wherein the desirable product is methane, hydrogen, a medium chain fatty acid, a lipid, acetate, an alcohol, a hydrocarbon, a polymerizable monomer, or a compound that is a precursor for production of a commercial or industrial chemical.

Embodiment 9. The composition of any one of Embodiments 1-8, wherein at least one species of microbe in the biofilm is selected based on its ability to exchange metabolites with another species of microbe in the biofilm.

Embodiment 10. A method of treating wastewater, the method comprising contacting wastewater with the composition of any one of Embodiments 1-9.

Embodiment 11. The method of Embodiment 10, wherein the wastewater comprises high strength wastewater.

Embodiment 12. The method of Embodiment 11, wherein the high strength wastewater comprises brewery wastewater.

Embodiment 13. The method of any one of Embodiments 10-12, wherein treatment of the wastewater produces methane.

Embodiment 14. The method of Embodiment 13, further comprising capturing at least a portion of the methane.

Embodiment 15. The method of any one of Embodiments 10-14, wherein treatment of the wastewater produces hydrogen gas.

Embodiment 16. The method of Embodiment 15, further comprising capturing at least a portion of the hydrogen gas.

Embodiment 17. The method of any one of Embodiments 10-16, wherein at least one species of microbe in the biofilm is selected based on its ability to consume a component of the wastewater.

Embodiment 18. The method of any one of Embodiments 10-17, wherein at least one species of microbe in the biofilm is selected based on its ability to produce a desirable product.

Embodiment 19. The method of Embodiment 18, wherein the desirable product is methane, hydrogen, a medium chain fatty acid, a lipid, acetate, an alcohol, a hydrocarbon, a polymerizable monomer, or a compound that is a precursor for production of a commercial or industrial chemical.

Embodiment 20. The method of any one of Embodiments 10-19, wherein at least one species of microbe in the biofilm is selected based on its ability to exchange metabolites with another species of microbe in the biofilm.

Embodiment 21. A composition comprising a first group of particles and a second group of particles, the first group of particles comprising a first biofilm encapsulated by a first encapsulant, the second group of particles comprising a second biofilm encapsulated by a second encapsulant.

Embodiment 22. The composition of Embodiment 21, wherein the first group of particles has a different average diameter than the second group of particles.

Embodiment 23. The composition of Embodiment 21, wherein the first encapsulant is different than the second encapsulant.

Embodiment 24. A method of treating wastewater, the method comprising contacting wastewater with the composition of any one of Embodiments 21-23.

Embodiment 25. The method of Embodiment 24, wherein the wastewater comprises high strength wastewater.

Embodiment 26. The method of Embodiment 25, wherein the high strength wastewater comprises brewery wastewater.

Embodiment 27. The method of any one of Embodiments 24-26, wherein treatment of the wastewater produces methane.

Embodiment 28. The method of Embodiment 27, further comprising capturing at least a portion of the methane.

Embodiment 29. The method of any one of Embodiments 24-28, wherein treatment of the wastewater produces hydrogen gas.

Embodiment 30. The method of Embodiment 29, further comprising capturing at least a portion of the hydrogen gas.

Embodiment 31. The method of any one of Embodiments 24-30, wherein at least one species of microbe in the biofilm is selected based on its ability to consume a component of the wastewater.

Embodiment 32. The method of any one of Embodiments 24-31, wherein at least one species of microbe in the biofilm is selected based on its ability to produce a desirable product.

Embodiment 33. The method of Embodiment 32, wherein the desirable product is methane, hydrogen, a medium chain fatty acid, a lipid, acetate, an alcohol, a hydrocarbon, a polymerizable monomer, or a compound that is a precursor for production of a commercial or industrial chemical.

Embodiment 34. The method of any one of Embodiments 24-33, wherein at least one species of microbe in the biofilm is selected based on its ability to exchange metabolites with another species of microbe in the biofilm.

Embodiment 35. A method of preparing a biofilm composition, the method comprising growing a community of microorganisms comprising at least two species of microbes on a biofilm-supporting surface to form a biofilm and encapsulating the biofilm with an encapsulant.

Embodiment 36. The method of Embodiment 35, wherein the biofilm-supporting surface comprises powdered activated carbon or biochar.

Embodiment 37. The method of Embodiment 35 or Embodiment 36, wherein at least one species of microbe in the biofilm is selected based on its ability to consume a component of wastewater.

Embodiment 38. The method of any one of Embodiments 35-37, wherein at least one species of microbe in the biofilm is selected based on its ability to produce a desirable product.

Embodiment 39. The method of Embodiment 38, wherein the desirable product is methane, hydrogen, a medium chain fatty acid, a lipid, acetate, an alcohol, a hydrocarbon, a polymerizable monomer, or a compound that is a precursor for production of a commercial or industrial chemical.

Embodiment 40. The method of any one of Embodiments 35-29, wherein at least one species of microbe in the biofilm is selected based on its ability to exchange metabolites with another species of microbe in the biofilm.

Embodiment 41. The method of any one of Embodiments 35-40, wherein at least one species of microbe in the biofilm is anaerobic.

Embodiment 42. The method of any one of Embodiments 35-41, wherein the community of microorganisms in the biofilm produces methane from wastewater.

Embodiment 43. The method of any one of Embodiments 35-42, wherein the community of microorganisms in the biofilm produces hydrogen gas from wastewater.

### Examples

The present invention is illustrated by the following examples. It is to be understood that the particular examples, materials, amounts, and procedures are to be interpreted broadly in accordance with the scope and spirit of the invention as set forth herein.

### Chemicals and Synthetic Wastewater Feed

A high-strength synthetic wastewater was used to mimic brewery wastewater as previously described (Zhu, et al., Bioresource Technology Reports, 2020, 11, 100451). Protein-free synthetic wastewater was made using the same recipe, excluding gelatin, casamino acids, and yeast extract. The pH of the synthetic wastewater was 6.5.

Powdered activated carbon (XS Plus CAT, average particle size 20 μm, Norit Nederland B.V., Amersfoort, Netherlands), medium viscosity sodium alginate, ammonium persulfate (APS; ≥98%), N,N,N′,N′-tetramethylethylene-diamine (99%), 2.0 mg/L bovine serum albumin standard, Folin & Ciocalteu's phenol reagent, sodium potassium tartrate tetrahydrate (ACS certified 99%), copper (II) sulfate pentahydrate (99.99%), and N,N′-methylene-bis-acrylamide (99%) were obtained from Sigma-Aldrich. Polyethylene glycol dimethacrylate (average molecular weight 1000 g/mol) was obtained from Polysciences, Inc. (Warrington, PA). Polyvinyl alcohol with a molecular weight of approximately 50,000-85,000 g/mol (98.0-98.8% hydrolyzed), sodium hydroxide, and low and high viscosity sodium alginate were obtained from Thermo Fisher Scientific, inc. (Waltham, MA). Sodium carbonate (ACS certified) was obtained from Spectrum Chemical Mfg. Corp. (New Brunswick, NJ). Polyvinyl alcohol (ELVANOL) was manufactured by Kuraray (Tokyo, Japan).

### Encapsulation and Encapsulation Chemistries

Anaerobic digester sludge from a local wastewater treatment plant was encapsulated in all experiments. Fermentative spore-forming cultures were selected for by incubating the bulk sludge in an oven at 103° C. for two hours. The sludge was then centrifuged at 6720 relative centrifugal force (RCF) (Beckman Coulter J6-HC) for 10 minutes and the supernatant was decanted and replaced with deionized water for encapsulation. The volatile suspended solids (VSS) of the fermentative cultures that were diluted with polymer solution and subsequently encapsulated, was approximately 1 g/L.

For methanogenic cultures, the anaerobic sludge was used as received. Anaerobic conditions were maintained during the centrifugation and encapsulation of the methanogenic consortium by handling sludge only in anaerobic containers and/or in an anaerobic glove bag (Coy Laboratory Products, Inc., Grass Lake, MI). The microbial culture was centrifuged to concentrate the biomass (6720 RCF for 10 minutes) and the supernatant was decanted and replaced with degassed and anaerobic deionized water for encapsulation. The VSS of the methanogenic culture that was diluted with polymer solution and subsequently encapsulated, was approximately 10 g/L. After the beads were formed, the protein measured in the beads was approximately 0.18 mg/bead. Experiments with lower concentrations of encapsulated biomass were also conducted to determine the impact of biomass concentration on performance. These beads were prepared identically but contained 0.036-0.10 mg protein/bead instead of 0.18 mg/bead.

Cultures were also prepared for the encapsulation of granular biomass or activated carbon-supported biofilms. Briefly, to prepare granular methanogenic cultures for encapsulation, equal volumes of raw anaerobic sludge and synthetic wastewater were mixed using a stir bar at 100 rpm at room temperature under anaerobic conditions with an HRT of eight days. After about four weeks, granules formed (approximately 0.1 mm in diameter). These granules were decanted and encapsulated in PEG, as described below. To prepare powdered activated carbon (PAC)-supported biofilms, raw anaerobic sludge (50 mL) and 0.3 g of PAC were added to 25 mL of synthetic wastewater in two identical 100 mL serum bottles. The serum bottles were sealed and purged with nitrogen gas and then placed on an orbital shaker at 50 rpm and 37° C. where they were mixed for 18 days. After 18 days, 40 mL of the supernatant was removed and replaced with an equal volume of fresh synthetic wastewater. After three additional days, the activated carbon was allowed to settle to the bottom of the serum bottle for 30 minutes and all but 10 mL of the supernatant was carefully decanted. The remaining material, primarily PAC-supported biofilm, was suspended in deionized water to a total volume of 30 mL to serve as the pre-polymer solution and was encapsulated in PEG beads as described below.

Alginate beads were prepared using the methods previously described (Zhu, et al., Environmental Science: Water Research & Technology, 2018, 4, 1867-1876). Briefly, 2% (w/v) medium viscosity sodium alginate was dissolved in deionized water. Fermentative beads were prepared on the bench top and methanogenic beads were prepared and rinsed anaerobically in a glove bag. The solution was extruded dropwise through an 18-gauge blunt needle into a stirred solution of 4% (w/v) calcium chloride and left to crosslink for 12 hours. Afterwards, beads were removed from solution and rinsed thoroughly with deionized water. Alginate beads were approximately 2.0 mm in diameter. To assess the amount of CaCO₃ and PAC that could be added to alginate beads to maximize bead strength, abiotic sodium alginate beads were amended with various weight fractions of CaCO₃ ranging from 1.0-10 wt % or PAC ranging from 1.0-5.0 wt %.

PVA/alginate beads were prepared by first dissolving 12% (w/v) PVA in 2% (w/v) sodium alginate by heating the solution to 80° C. in a hot water bath. The mixture was cooled to room temperature before an equal volume of fermentative organisms in DI water was added. The solution was extruded dropwise through an 18-gauge blunt needle into a stirred solution of 4% (w/v) calcium chloride and 4% (w/v) boric acid solution and left to crosslink for 12 hours. Beads were removed from solution and rinsed thoroughly with deionized water.

A core-shell encapsulant was constructed using a modified version of a previously described procedure (Bae, et al., Chemical Engineering Journal, 2017, 322, 408-416). A 12:2:5% (w/v) ratio of PVA:alginate:PAC core with fermentative microbes was surrounded by a 12:2% (w/v) abiotic PVA:alginate shell. In the modified procedure, cores were constructed as above, where 5% (w/v) PAC was added to the solution prior to crosslinking for 30 minutes. A second 12/2% PVA/alginate solution was prepared for the shells and poured into 1-cm hemispherical silicone molds. One core was placed in each divot in the mold. The cores were pushed into the center of the shell mixture. Crosslinking was allowed in the molds for five minutes to facilitate diffusion of the crosslinking solution out of the cores and hardening of the shell surrounding the cores. Finally, the beads were moved into a new solution of boric acid and calcium chloride overnight to fully harden. Beads were then removed from solution and rinsed thoroughly with deionized water.

PEG beads were prepared adapting a previously described method (Sumino, et al., Journal of Fermentation and Bioengineering, 1992, 73, 37-42). Instead of pouring and cutting large sheets of polymer, hemispherical 1-cm silicone molds were used to create individual beads. Additionally, the concentration of the ammonium persulfate (APS) initiator was reduced to allow for time to transfer the polymer solution to the molds before the mixture solidified. Fermentative beads were prepared on the bench top and methanogenic beads were prepared and rinsed anaerobically in a glove bag. Briefly, a solution of microbes that were centrifuged (and heat-treated, in the case of the fermentative culture) as described above was added to deionized water to achieve the desired biomass concentration and volume of pre-polymer solution. Approximately 30 mL of pre-polymer solution was used to produce 50 beads. This solution was mixed with 18% (w/v) polyethylene glycol dimethacrylate (PEGDMA) until the PEGDMA was dissolved. The crosslinking agent N,N′-methylene-bis-acrylamide and the catalyst N,N,N′,N′-tetramethylethylene-diamine were then added to a final concentration of 1% and 0.5% w/v, respectively, and mixed well. Finally, the APS initiator was added to a final concentration of 0.1% (w/v), and the mixture was immediately poured into the silicone molds and leveled. Polymerization was complete within ten minutes, after which the beads were removed, rinsed thoroughly with deionized water, and used. PEG beads were approximately 10 mm in diameter.

### Batch Reactors

To measure whether bead chemistries were inhibitory to microbial activity, the production of hydrogen and methane was monitored over time in batch reactors. Triplicate serum bottles containing 25 mL of synthetic wastewater and 10 mL of beads containing either fermentative or methanogenic cultures were sealed with butyl rubber stoppers and aluminum crimp caps and purged with nitrogen. The serum bottles were agitated on an orbital shaker at 50 rpm and 37° C. Total gas production and gas composition were measured daily for 7-10 days. The specific gas production rate was calculated by determining the quantity of gas produced each day (mmol/day) and dividing it by the biomass present in the number of beads present (mg protein). The average gas production rate per bead was calculated by determining the total amount of gas produced over the course of an experiment (mmol) and dividing it by the number of beads present and the length of the experiment (days).

### Three-Stage Reactors

To measure the leakage of microbes from beads and the effect of this leakage on overall activity, three-stage reactors were constructed. First, beads (5 mL total volume) were placed in triplicate anaerobic batch reactors containing 25 mL of synthetic wastewater for five days to assess their activity by tracking gas (hydrogen or methane) production. The number of whole beads and the quality of those beads before the five-day incubation period were noted. A bead from each reactor was also taken and stored at −20° C. for protein measurement, as described below.

After five days, beads were transferred into triplicate plug flow reactors (PFRs) and fed synthetic protein-free wastewater for three weeks. The PFRs were operated with an HRT of 45 minutes to allow for any leaked organisms to flow out of the system. Flow-through reactors were operated on the bench for fermentative cultures and in an anaerobic glove bag for encapsulated methanogenic cultures. PFRs were constructed from 7 mL polypropylene syringes (MONOJECT, Cardinal Health LLC, Dublin, OH) with the plungers removed. The effluent ends of the syringes were plugged with approximately 1 mL of glass wool to prevent the beads from flowing out of the reactors and the syringe tips were fitted with silicone tubing. The beads were then placed inside the syringe bodies and the influent ends of the reactors were closed with rubber stoppers (SUBA-SEAL, Merck KGAA, Darmstadt, Germany) through which a needle and tubing were inserted.

Finally, in phase three, beads were removed from the PFRs, thoroughly rinsed with deionized water, and then placed back in anaerobic batch reactors containing 25 mL of fresh synthetic wastewater. Gas production and hydrogen and methane concentration were then measured over five days. The number of whole beads present and bead quality were recorded after this final five-day incubation period. Again, a bead was removed from each reactor and stored at −20° C. for protein measurement. All manipulation of encapsulated methanogenic cultures was performed in an anaerobic glove bag.

Two alternative three-stage reactor set-ups were also used to test the longevity of the PEG beads encapsulating PAC-supported biofilms. In these experiments, two different types of fill-and-draw reactors were used instead of the flow-through PFRs in the second stage. For one reactor type, so called “caged reactors,” 33 mL stainless steel tea infusers were filled with 37 PEG beads containing PAC-supported biofilm. The infusers were hung inside a 250 mL beaker filled with 200 mL synthetic wastewater. A stir bar and plate were used to rapidly stir the solution. Every four days, half of the media was removed and replaced with new media. The reactors were operated for 21 days. For the second reactor type, upflow reactors were operated using triplicate 250 mL polypropylene centrifuge tubes (Celltreat Scientific Products, Pepperell, MA), each containing 30 PEG beads containing PAC-supported biofilm in 175-mL of synthetic wastewater. Synthetic wastewater was circulated through the system from the bottom in an upflow pattern at a rate of 4 mL/min. Every four days, half of the media was removed and replaced with new media. The reactors were operated for 10 days.

### Stirred and Impeller Reactor Experiments

Finally, two additional experiments were performed to determine bead longevity using magnetically stirred and overhead impeller reactors. Bench-top stirred reactors included 30 PEG beads encapsulating PAC-supported biofilms, each in triplicate 150-mL Erlenmeyer flasks, containing 100 mL of deionized water and a stir bar. The reactors were stirred rapidly for two weeks, and bead quality was observed daily. Bench-top impeller reactors used a Phipps & Bird PB-700 jar tester to stir triplicate 500 mL beakers, each containing 30 PEG beads encapsulating PAC-supported biofilms and 400 mL of deionized water, each at 50 rpm for two weeks, and bead quality was observed daily. Gas production and bead protein concentrations were not monitored in these experiments.

### Analytical Methods

The volume of gas produced in sealed batch reactors was measured using the volume displacement method previously described (Zhu et al., Environmental Science: Water Research & Technology, 2018, 4, 1867-1876). The composition of gas samples was analyzed using a gas chromatograph (6890 series, Hewlett Packard, Inc., Palo Alto, CA) equipped with a packed column (SUPELCO/13981-U, L×O.D.×I.D., 3.0 m×3.175 mm×2.1) coupled to a thermal conductivity detector (GC-TCD) using the method described (Chen et al., Bioresource Technology, 2022, 126435). Hydrogen and methane standards were prepared with known volumes of high purity gas. The instrument was operated with an injector temperature of 200° C., an oven temperature of 70° C., and a detector temperature of 210° C. The carrier gas was argon. The limits of detection were 8.1×10⁻⁷ moles of hydrogen and 5.9×10⁻⁷ moles of methane.

To measure biomass as protein in the encapsulant beads, alginate beads were dissolved in 0.5 mL deionized water saturated with sodium citrate and PEG beads were manually crushed to fine pieces using a Phillips-head screwdriver in 0.5 mL of deionized water. After dissolution or breakage, samples were frozen at −20° C. for up to one month. For analysis, samples were thawed to room temperature and 0.5 mL of a 5% sodium dodecyl sulfate (SDS) buffer solution was added to each sample. The 1.0 mL samples were sonicated for five minutes to dislodge the biomass from the polymer matrix. Finally, the samples were subjected to two freeze/thaw cycles at −20° C.; 1.0 mL of the liquid was sub-sampled for analysis of protein as previously described (F. Hartree, Analytical Biochemistry, 1972, 48, 422-427). Briefly, sodium potassium tartrate, sodium carbonate, sodium hydroxide, and copper (II) sulfate pentahydrate were added in a series of steps to the sample and heated in a water bath to 50° C. The reaction between the reagents and the protein in the sample formed a blue color, the absorbance of which was linearly proportional to the amount of protein present. For beads containing PAC, the activated carbon was allowed to settle to the bottom of the solution for 4-8 hours before absorbance was measured. Standards were determined by measuring the absorbance of known concentrations of bovine serum albumin (BSA) over a range of 0-80 mg/L. A Synergy LX Multi-mode 96 well plate reader at 650 nm was used to measure sample absorbance. The detection limit was 1.60 mg/L.

### Statistical Analysis

Two-sample t-tests assuming unequal variances were performed using Microsoft Excel. Unless otherwise stated, results with P-values less than or equal to 0.05 were the focus of discussion.

The complete disclosure of all patents, patent applications, and publications, and electronically available material (including, for instance, nucleotide sequence submissions in, e.g., GenBank and RefSeq, and amino acid sequence submissions in, e.g., SwissProt, PIR, PRF, PDB, and translations from annotated coding regions in GenBank and RefSeq) cited herein are incorporated by reference in their entirety. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

What is claimed is:

1. A composition comprising:
a biofilm comprising at least two species of microbes; and
an encapsulant encapsulating the biofilm.

2. The composition of claim 1, wherein the biofilm comprises a support material on which at least a portion of the microbes grow.

3. The composition of claim 2, wherein the support material comprises biochar or powdered activated carbon.

4. The composition of claim 1, wherein members of the at least two species of microbes are in sufficient proximity to exchange metabolites.

5. The composition of claim 1, wherein the encapsulant includes polyethylene glycol (PEG).

6. The composition of claim 1, wherein at least one species of microbe in the biofilm is selected based on its ability to consume a component of wastewater.

7. The composition of claim 1, wherein at least one species of microbe in the biofilm is selected based on its ability to produce a desirable product.

8. The composition of claim 7, wherein the desirable product is methane, hydrogen, a medium chain fatty acid, a lipid, acetate, an alcohol, a hydrocarbon, a polymerizable monomer, or a compound that is a precursor for production of a commercial or industrial chemical.

9. The composition of claim 1, wherein at least one species of microbe in the biofilm is selected based on its ability to exchange metabolites with another species of microbe in the biofilm.

10. A method of treating wastewater, the method comprising contacting wastewater with the composition of claim 1.

11. A composition comprising:
a first group of particles, the first group of particles comprising:
a first biofilm encapsulated by a first encapsulant; and
a second group of particles, the second group of particles comprising:
a second biofilm encapsulated by a second encapsulant.

12. The composition of claim 11, wherein the first group of particles has a different average diameter than the second group of particles.

13. The composition of claim 11, wherein the first encapsulant is different than the second encapsulant.

14. A method of treating wastewater, the method comprising contacting wastewater with the composition of claim 11.

15. The method of claim 14, wherein the wastewater comprises high strength wastewater.

16. The method of claim 15, wherein the high strength wastewater comprises brewery wastewater.

17. The method of claim 14, wherein treatment of the wastewater produces methane.

18. The method of claim 14, wherein treatment of the wastewater produces hydrogen gas.

19. The method of claim 14, wherein at least one species of microbe in the biofilm is selected based on its ability to consume a component of the wastewater.

20. The method of claim 14, wherein at least one species of microbe in the biofilm is selected based on its ability to produce a desirable product.

21. The method of claim 14, wherein at least one species of microbe in the biofilm is selected based on its ability to exchange metabolites with another species of microbe in the biofilm.

22. A method of preparing a biofilm composition, the method comprising:
growing a community of microorganisms comprising at least two species of microbes on a biofilm-supporting surface to form a biofilm; and
encapsulating the biofilm with an encapsulant.

23. The method of claim 22, wherein the biofilm-supporting surface comprises powdered activated carbon or biochar.

24. The method of claim 22, wherein at least one species of microbe in the biofilm is selected based on its ability to consume a component of wastewater.

25. The method of claim 22, wherein at least one species of microbe in the biofilm is selected based on its ability to produce a desirable product.

26. The method of claim 22, wherein at least one species of microbe in the biofilm is selected based on its ability to exchange metabolites with another species of microbe in the biofilm.

27. The method of claim 22, wherein at least one species of microbe in the biofilm is anaerobic.

28. The method of claim 22, wherein the community of microorganisms in the biofilm produces methane from wastewater.

29. The method of claim 22, wherein the community of microorganisms in the biofilm produces hydrogen gas from wastewater.
